(19) United States
(12) Patent Application Publication
(10) Pub. No.: US 2006/0021230 A1
(43) Pub. Date: Feb. 2, 2006

(54) Abrasion-free scissors for hairdressing and like applications

(76) Inventor: Akira Mikami, Suita (JP)

Correspondence Address: KODA & ANDROLIA, 2029 CENTURY PARK EAST, SUITE 1140, LOS ANGELES, CA, 90067, US

(21) Appl. No.: 11/172,038

(22) Filed: Jun. 30, 2005

(30) Foreign Application Priority Data
Jun. 30, 2004 (JP) 2004-193711

(51) Int. Cl. B26B 13/00

(52) U.S. Cl. 30/194

(57) ABSTRACT

The pair of cutting blades are pin joined to each other at their terminal webs which are joined to bow handles. A ball bearing is mounted to the pivot pin by way of an antifriction spacer for providing a permanent spacing between the terminal webs in order to prevent the same from abrasion and consequent uneven wear. A clamp is coupled at one end to the pivot pin projecting from one of the terminal webs, and anchored at another end to the other terminal web, in order to bear the component of cutting resistance which tends to spread the pair of blades in opposite directions away from their parallel planes of motion.

### BACKGROUND OF THE INVENTION

This invention relates generally to scissors inclusive of those commonly classified as shears. More particularly, the invention deals with an abrasion-free, light-action, long-lasting pair of scissors well suited for use in hairdressing salons or barbershops, permitting the hairdressers or barbers to cut and trim hair using the latest, most fashionable techniques, although no unnecessary limitations to this particular application are intended.

Among the simplest of man-made tools, the pair of scissors consists essentially of two blades, complete with handles, which are medially pin-jointed to each other for pivotal motion in parallel planes. The blades, or their cutting edges to be exact, slide across each other to provide the cutting action when the handles are closed. When cutting, the blades encounter resistance not only in a direction to resist the closing of the handles but, additionally, in a direction to spread the blades in opposite directions away from their parallel planes of motion.

With the conventional scissors in general, the second recited component of the cutting resistance caused the blades to frictionally engage each other flatwise in limited areas on their terminal webs where the blades are pivotally coupled to each other. These limited areas of the terminal webs, on the handle side of the pivot pin, are herein termed “contact zones” and will be referred to time and again as they are closely associated with the gist of the instant invention. The contact zones delineate arcuate shape, centered about the axis of the pivot pin, as the blades swing in sliding engagement with each other.

For cutting, therefore, the handles must be pressed toward each other with a sufficient force to overcome the resistance. The cutting edges of the blades will then slide one over the other, with the confronting faces of the blades closely held together, as the contact zones on the terminal webs of the blades are conventionally urged by reaction against each other and slide in frictional interengagement, fully bearing the cutting resistance tending to spread the blades away from their parallel planes of motion. The scissors will thus operate successfully only if a force is exerted thereon that is great enough to defeat the cutting resistance.

In some instances, however, the manual effort on the handles may fall short of the force demanded by the particular scissors for cutting the particular object, regardless of whether the scissors is being used by some specialist or otherwise. One such instance in the case of specialists manifests itself when the scissors are held in other than the normal fashion by hairdressers or stylists owing to the customs or requirements of their occupations. The cutting edges of the blades may not be urged sufficiently strongly against each other in such cases and so fail to cut smoothly or to cut at all.

Let us now consider how scissors are being used today by hair stylists or dressers and some barbers. A variety of novel hair styles are being advocated year after year, or season after season, and with them, novel hair cutting methods that match these styles. Currently in vogue among such novel cutting methods are those which involve the speedy flourishing of the scissors for finely trimming the hair. The flourishing of the scissors, however, is counteractive to the manipulation, in the narrower sense of the word, of the scissors which involves the application of a constant closing force on the bows or handles by the thumb and fingers. It is indeed a professional feat to flourish the hand and manipulate the scissors with that flourishing hand as this same hand must be intricately bent and twisted for cutting different parts of the scalp hair at different angles. For proper scissors manipulation, moreover, an application of sufficient compressive forces to the handles by the thumb and fingers is a prerequisite for keeping the cutting edges of the blades in proper sliding engagement with each other.

A hairdresser confesses that it has not been rare, while practicing the flourishing cutting styles, for him to yank at the customer's hairs and even pull some off. These mishaps have so far been avoidable only by unfailing exertion of utmost manual, as well as digital, effort on the handles of the scissors, a practice that led infallibly to hand fatigue and inflammation, sore thumb, and stiff shoulders.

Barbers and hairdressers alike have therefore long awaited the advent of lighter-action, smoother-cutting scissors that meet the requirements of the latest cutting fashions. Japanese Unexamined Patent Publication No. 11-244550, filed by the applicant of the instant U.S. application, represents a conventional attempt at provision of such scissors (FIGS. 1 and 2 of the drawings attached hereto), which is closest to this invention as far as the applicant is aware. This prior art pair of scissors has a cantilever spring embedded at one end in the handle end of the top blade (i.e. blade with the thumb bow). The other, free end of the cantilever spring is bored to fit over the bolt joining the two blades of the scissors and is urged against the bottom blade (i.e. blade with the bow in which one or more fingers are placed) by the nut on the bolt.

Thus the handle ends of the two blades, including the noted contact zones, of the prior art scissors are spring-biased into face-to-face sliding contact with each other. No matter how they are used, no matter how wildly they are brandished, the spring-assisted scissors will cut smoothly with the exertion of minimal digital effort on the handles. It is not surprising that this prior art implement is winning acceptance among some hairdressers and barbers.

There does, however, exist a problem yet unresolved in connection with the prior art spring-assisted scissors above. Sprung against each other, the contact zones of their blades are susceptible to abrasion, as are those of all the more conventional scissors relying on the contact zones for bearing the cutting resistance. The resulting uneven wear of the blades is detrimental to the performance of the scissors. The hairdressers and barbers who currently favor the spring-assisted scissors are certain to find it increasingly more difficult to manipulate them with the lapse of time. This is because, with the progress of abrasion, the contact zones become less and less capable of bearing the cutting resistance, demanding an exertion of more and more manual effort. The scissors with the worn contact zones will offer no such good run, no such even, clear cut without hesitation, as when they were unworn. Of course, the uneven wear of the blades is repairable, or avoidable by periodic reconditioning, but at the costs of considerable time and expenses as the scissors must usually be sent back to the manufacturer for such purposes. Local repair services often prove unsatisfactory or even damaging.

It might be contemplated to preclude the uneven wear of the blades by spacing the handle ends of the blades from each other. Such scissors, having no contact zones to bear the cutting resistance, would not cut at all because, as has been explained above, the cutting edges of the blades would be displaced away from their cutting planes.

### SUMMARY OF THE INVENTION

It is among the objects of this invention to provide a materially improved, in a sense even revolutionary, pair of scissors which is perhaps best suited for hairdressing applications, among others, permitting use of the latest, scissors-flourishing cutting styles without any of the accompanying inconveniences or difficulties pointed out above with respect to the conventional scissors.

Another, more specific object of the invention is to create a permanent spacing between the terminal webs, including the easy-to-be-worn conventional contact zones, of the pair of blades in order to preclude the mutual abrasion of the blades at these parts and hence to render the scissors fit for use over incomparably longer periods of time then hitherto without repair or reconditioning.

Yet another object of the invention is, despite the permanent spacing created between the terminal webs of the pair of blades, to cause their handle end regions to be constantly urged toward each other in opposition to the cutting resistance and hence to make the scissors just as cutting as if the blades were directly held against each other at the contact zones as in the prior art.

Still another object of the invention is to minimize the friction of the blades between themselves and with other parts thereby making the scissors as light in action as feasible in order to save barbers and hairdressers from their professional ailments.

Briefly, the present invention may be summarized as an abrasion-free, lighter-action, longer-lasting pair of scissors particularly well suited for hairdressing or styling applications, among others. Included are a pair of blades each having a terminal web through which the blade is joined to a handle. A pivot pin conventionally extends through the terminal webs of the pair of blades to permit pivotal motion of the blades relative to each other in parallel planes. A spacer is mounted between the terminal webs of the pair of blades for creating a spacing therebetween. Also included is a clamp having one end which is coupled to one end of the pivot pin projecting outwardly from one of the terminal webs and which is held against said one terminal web, and another end anchored to the other terminal web, in order to enable the terminal webs to bear that component of cutting resistance which tends to spread the pair of blades in opposite directions away from their parallel planes of motion.

Thus the scissors is saved from the abrasion and consequent uneven wear of the terminal webs of the pair of blades as they are totally spaced from each other. The spacing of the terminal webs does not adversely affect the performance of the scissors at all, thanks to the provision of the clamp. Unlike the cantilever spring in the prior art scissors cited above, this clamp needs no resiliency as it functions to bear the resistance component tending to spread the pair of blades out of their parallel cutting planes, just as firmly as if the terminal webs were directly urged against each other at what were conventionally termed the contact zones. The operator may therefore exert only minimal manual effort for cutting. Furthermore, since the terminal webs are not to be worn at all, the scissors will remain as cutting as at the time of purchase as long as the edges of the blades do not dull.

A bolt is recommended for use as the pivot pin joining the two blades of the scissors. The nut (usually cap nut) on the bolt may then be used for adjustment of pressure under which the clamp is held against the terminal webs.

It is also recommended that a ball bearing, or simply a set of balls, be used as the spacer between the terminal webs. The spacer balls may be confined around the pivot pin for rolling engagement with both of the terminal webs of the pair of blades. The scissors will then be assured of even lighter action by virtue of the absence of friction between the terminal webs.

According to an additional feature of the invention, another set of antifriction balls may be rollably confined around the pivot pin for rolling engagement with both clamp and one of the terminal webs. Still lighter action of the scissors will result from the absence of friction between the clamp and one of the terminal webs.

The above and other objects, features and advantages of this invention will become more apparent, and the invention itself will best be understood, from a study of the following description and appended claims, with reference had to the attached drawings showing the closest prior art and a preferable embodiment of the invention.

### BRIEF DESCRIPTION OF THE DRAWINGS

FIG. 1 is a partial perspective view of the prior art pair of scissors being particular pertinence to the present invention;

FIG. 2 is a slightly enlarged section through the prior art scissors of FIG. 1;

FIG. 3 is a perspective view of the scissors built on the novel principles of this invention; and

FIG. 4 is an enlarged, fragmentary section through the inventive scissors of FIG. 3.

### DETAILED DESCRIPTION

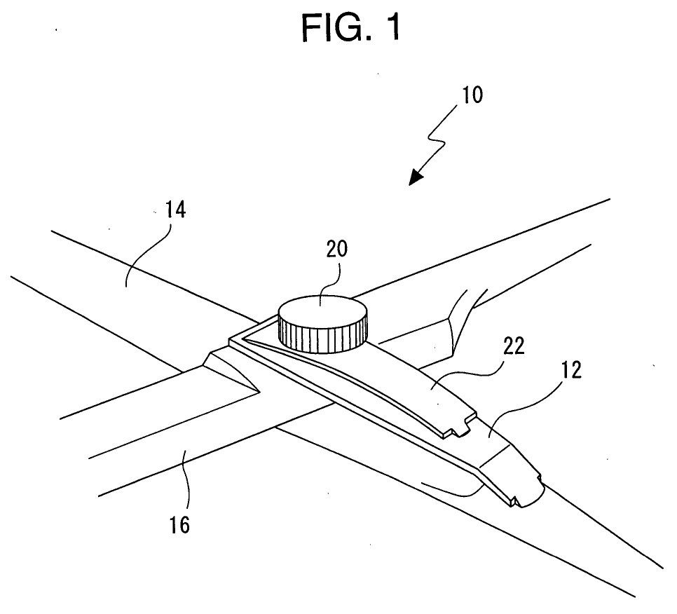

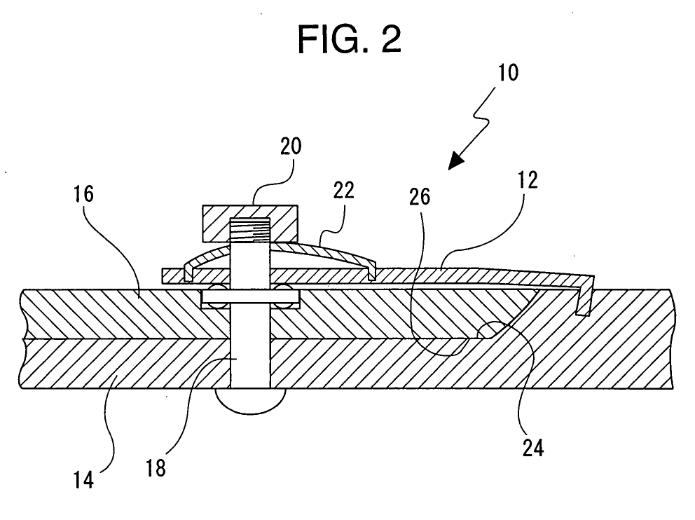

A closer examination of the prior art spring-assisted scissors according to Japanese Unexamined Patent Publication No. 11-244550, supra, will redound to a better appreciation of the features and advantages of the spaced-blade scissors according to the invention. With reference to both FIGS. 1 and 2 the prior art pair of scissors 10 has a cantilever spring 12 having a bent end embedded in the handle end of one blade 14, and another end held against the other blade 16 and bored to fit over a bolt 18 pivotally joining the two blades 14 and 16. A cap nut 20 on the bolt 18 is tightened to force the blades 14 and 16 against each other via the cantilever spring 12 and an adjusting leaf spring 22.

Sprung as above, the prior art scissors makes it mostly unnecessary for the operator to exert an additional force for holding the contact zones 24 and 26 of the blades 14 and 16 in sliding engagement with each other during cutting. These contact zones 24 and 26 will sooner or later be worn to such an extent as to become unable to bear the cutting resistance, demanding an application of a proportionately greater -force to the handles for cutting. Although the cap nut 20 on the bolt 18 is retightenable by the user, the blades 14 and 16 when worn excessively are repairable only by skilled artisans.

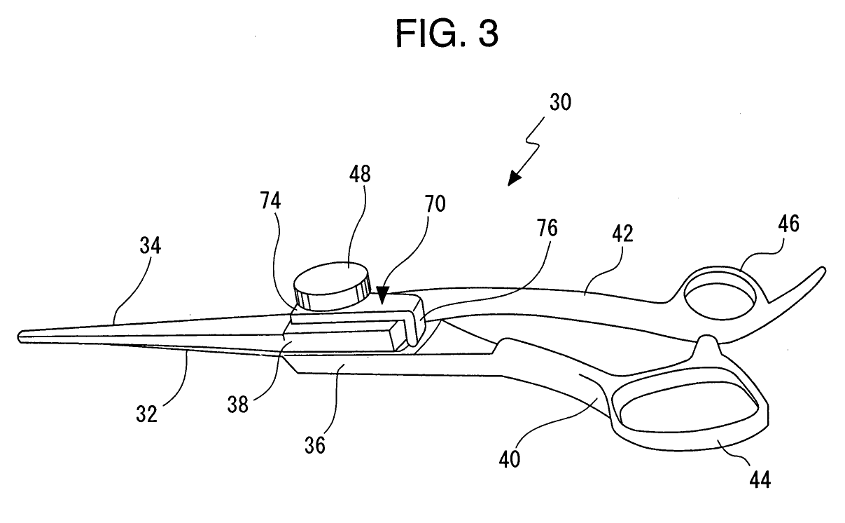

Reference may now be had to FIG. 3 for a detailed study of the general configuration of one preferred form of abrasion-free, longer-lasting, lighter-action pair of scissors embodying the principles of the present invention. Generally designated 30, the illustrated scissors has a pair of blades 32 and 34 having terminal webs 36 and 38 which are joined to handles 40 and 42, respectively. The blade 32 with a thumb bow 44 on the handle 40 is conventionally called the “A” blade, and the blade 34 with a finger bow 46 on the handle 42 the “B” blade. Both “A” and “B” blades 32 and 34 have their terminal webs 36 and 38 joined together by a pivot pin which in this particular embodiment takes the form of a bolt complete with a cap nut 48.

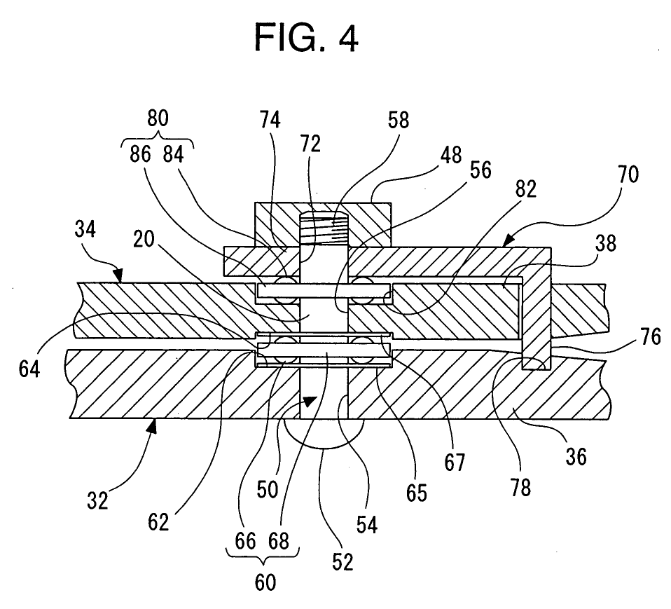

FIG. 4 reveals at 50 the bolt joining the blades 32 and 34. The bolt 50, with a head 52, slidably extends through a hole 54 in the terminal web 36 of the “A” blade 32 and a hole 56 in the terminal web 38 of the “B” blade 34. The noted cap nut 48 is fitted over the threaded end 58 of the bolt 50 projecting outwardly of the hole 56. Thus the blades 32 and 34 are pivotable in parallel planes about the bolt 50 as the handles 40 and 42 are opened and closed.

Installed between the blades 32 and 34 and encircling the bolt 50 is what may be termed an antifriction spacer 60 for providing a permanent spacing between the terminal webs 36 and 38 without itself introducing friction as it contacts these terminal webs. The antifriction spacer 60 is shown as a ball bearing received in part in a recess 62 in the terminal web 36 and in part in a recess 64 in the terminal web 38. The ball bearing 60 comprises an annular row of balls 66 rollably confined by a ring 68 around the bolt 50. It is the balls 66 that make antifriction contact with both terminal webs 36 and 38. The balls 66 are sufficiently large, in relation to the depths of the recesses 62 and 64 in which they are received, to create a permanent spacing between the terminal webs 36 and 38 including their surface portions that have so far been called the contact zones by the scissors specialists.

It is understood that the blades 32 and 34 are both conventionally equipped with bow and twist, such that, despite the spacing between their terminal webs 36 and 38, the blades have their tips held against each other when the handles 40 and 42 are closed. Further, while the handles 40 and 42 are being opened and closed, the cutting edges of the blades 32 and 34 slide across each other for cutting.

Preferably, the spacing between the terminal webs 36 and 38 should be adjustable. Employed to this end are a washer or washers 65 between terminal web 36 and ball bearing 60 and another washer or washers 67 between terminal web 38 and ball bearing 60. The number of washers 65 and 67 may be varied to optimize the spacing between the terminal webs 36 and 38.

The creation of a permanent spacing between the terminal webs 36 and 36 represents a departure from, or indeed a negation of, the long-familiar scissors design. Any conventional type of scissors would not cut at all should their terminal webs be left spaced from each other. The scissors 30 according to the instant invention cuts just as well as if they had contact zones in sliding engagement with each other, thanks to the provision of a clamp 70 seen in both FIGS. 3 and 4. This clamp 70 is designed to prevent the cutting edges of the pair of blades 32 and 34 from being displaced away from their parallel cutting planes under the influence of the cutting resistance, that is, to hold the handle ends of the terminal webs 36 and 38 urged against each other in the face of the cutting resistance, as hereinafter described in detail.

Made of a rather elongate piece of sheet metal, the clamp 70 has a bore 72 adjacent one end 74 thereof to fit over the end of the bolt 50 projecting from the “B” blade 34. The clamp 70 extends from the bolt 50 over the terminal web 38 of the “B” blade 34 toward its handle and has another end 76 thereof bent over the handle end of this terminal web 38 toward the terminal web 36 of the “A” blade 32. The bent end 76 of the clamp 70 is engaged in a depression 78 formed in the inside surface of the terminal web 36 at or adjacent of what was conventionally the contact zone of this terminal web. The clamp 70 is thus locked against pivotal displacement about the bolt 50 relative to the “A” blade 32, but the “B” blade 34 is free to turn relative to the clamp and, of course, to the “A” blade.

It is recommended that a second antifriction spacer 80 be installed between the “B” blade 34 and the clamp 70 for minimal sliding resistance. This second antifriction spacer may also take the form a ball bearing operably engaged in a recess 82 in the outer surface of the terminal web 38 of the “B” blade 34 and concentrically surrounding the bolt 50. The ball bearing 80 comprises a row of balls 84 and an outer confining ring 86. The balls 84 make rolling engagement with both “B” blade 34 and clamp 70, permitting the former to be turned frictionlessly with respect to the latter.

The bolt 50 has its screw-threaded end projecting further outwardly of the clamp 70 for mating engagement with the cap nut 48. The tightening of this cap nut 48 on the bolt 50 will therefore cause the clamp 70 to be held both against the outside surface of the terminal web 38 of the “A” blade 32 and, via the ball bearing 80, against the inside surface of the terminal web 36 of the “B” blade 34. Thus, even though the terminal webs 36 and 38 are spaced from each other, they are equivalently urged against each other via the clamp 70 at their handle sides of the bolt 50 in opposition to the component of the cutting resistance tending to spread the blades 32 and 34 away from their cutting planes.

The cap nut 48 may be retightened on the bolt 50 in cases where more than normal resistance is expected in use of the scissors 30 for cutting some objects. The terminal webs 36 and 38 will then be urged harder toward each other via the clamp 70, enabling the scissors 30 to cut well despite the unusually great resistance.

Whatever object is to be cut, the scissors will demand an exertion of literally minimal manual effort not only because of the constant urging of the handle sides of the terminal webs 36 and 38 toward each other via the clamp 70 but, additionally, of the absence of frictional resistance between the terminal webs 36 and 38 and between the terminal web 38 and clamp 70. The scissors 30 is therefore particularly well suited for use by hairdressers or barbers who have to manipulate the implement over prolonged periods of time and sometimes in extraordinary manners.

Notwithstanding the foregoing detailed disclosure it is not desired that the present invention be limited by the exact showing of the drawings or the description thereof. It is understood that the principles of this invention are applicable to various types of scissors or shears in addition to that for hairdressing represented here. Further a variety of modifications or alterations of the illustrated embodiment will suggest themselves to the specialists to conform to design preferences or to the requirements of each specific application of the invention, without departing from the proper scope or fair meaning of the invention as expressed in the claims which follow.

What is claimed is:

1. An abrasion-free, light-action pair of scissors well suited for hairdressing or styling applications, among others, comprising:
(a) a pair of blades each having a terminal web;
(b) a pivot pin joining the terminal webs of the pair of blades to each other to permit pivotal motion of the blades relative to each other in parallel planes, the pivot pin having one end projecting outwardly of one of the terminal webs;
(c) a spacer mounted between the terminal webs of the pair of blades for creating a spacing between the terminal webs; and
(d) a clamp having one end which is coupled to said projecting end of the pivot pin and which is held against said one terminal web, and another end anchored to the other terminal web, in order to enable the terminal webs to bear a component of cutting resistance tending to spread the pair of blades in opposite directions away from their parallel planes of motion;
(e) whereby the scissors is saved from the abrasion and consequent uneven wear of the terminal webs of the pair of blades without sacrifice in performance.

2. An abrasion-free, light-action pair of scissors as defined in claim 1, wherein said other end of the clamp is engaged in a depression formed in said other terminal web.

3. An abrasion-free, light-action pair of scissors as defined in claim 1, wherein the pivot pin is a bolt having a nut for holding the clamp against the terminal webs under adjustable pressure.

4. An abrasion-free, light-action pair of scissors as defined in claim 1, wherein the spacer comprises a plurality of balls rollably confined around the pivot pin and making rolling engagement with both of the terminal webs of the pair of blades.

5. An abrasion-free, light-action pair of scissors as defined in claim 4, further comprising washer means installed between the balls and at least either of the terminal webs of the pair of blades.

6. An abrasion-free, light-action pair of scissors as defined in claim 1, further comprising a plurality of balls rollably confined around the pivot pin and making rolling engagement with both of the clamp and said one terminal web.
